(19) United States
(12) Patent Application Publication
(10) Pub. No.: US 2016/0363367 A1
(43) Pub. Date: Dec. 15, 2016

(54) COMPONENT FOR A REFRIGERATOR APPLIANCE HAVING AN INTEGRATED HEATER

(71) Applicant: General Electric Company, Schenectady, NY (US)

(72) Inventor: Joel Erik Hitzelberger, Louisville, KY (US)

(21) Appl. No.: 14/737,813

(22) Filed: Jun. 12, 2015

(51) Int. Cl. F25D 23/12; C25D 5/34; C25D 3/38; F25D 23/06; H01R 24/20

(52) U.S. Cl. CPC F25D 23/12; F25D 23/066; F25D 23/062; F25D 23/061; H01R 24/20; C25D 3/38; C25D 5/34

(57) ABSTRACT

A component for a refrigerator appliance including a body is provided. The body includes a surface and the component further includes an electrically conductive path positioned on the surface of the body. The electrically conductive path is formed using a laser direct structuring process, such that when the electrically conductive path is provided with electrical power, the electrically conductive path may provide heat to the surface of the body of the component.

### FIELD OF THE INVENTION

The present subject matter relates generally to components for appliances, such as refrigerator appliances, having a heater integrated therein.

### BACKGROUND OF THE INVENTION

Certain refrigerator appliances utilize sealed systems for cooling chilled chambers of the refrigerator appliances. A typical sealed system includes an evaporator and a fan, the fan generating a flow of air across the evaporator and cooling the flow of air. The cooled air is then provided through a supply duct to an opening into the chilled chamber to maintain the chilled chamber at a desired temperature. Air from the chilled chamber is circulated back through a return duct to be re-cooled by the sealed system during operation of the refrigerator appliance, maintaining the chilled chamber at the desired temperature.

The supply duct through which cooled air is provided to the chilled chamber is thus subjected to relatively cool temperatures. Accordingly, during operation of the refrigerator appliance, condensation may form on an outside surface of the supply duct, as the outside surface of the supply duct may be at a temperature below a dew point temperature. The condensation can then drip and form a pool of water on the floor beneath the refrigerator appliance, which may give a consumer an impression that the refrigerator appliance is a faulty refrigerator appliance or an inferior refrigerator appliance.

Accordingly, certain refrigerator appliances additionally include a separate heater positioned on the outside surface of the supply duct to raise a temperature of the outside surface of the supply duct above the dew point temperature. However, the separate heater can take up space within a cabinet of the refrigerator appliance, reducing a usable volume of space within the chilled chambers. Additionally, incorporating a separate heater can also be costly.

Therefore, a refrigerator appliance capable of heating an outside surface of the supply duct without requiring a bulky separate heater would be useful. More particularly, a refrigerator appliance capable of heating an outside surface of the supply duct without reducing a usable volume of space within the chilled chambers would be particularly beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, a refrigerator appliance is provided. The refrigerator appliance includes a sealed system for cooling air, a cabinet including a liner defining a chilled chamber, and a duct configured to allow a flow of cooled air from the sealed system to the chilled chamber defined by the liner. The duct includes a surface having an electrically conductive path formed using a laser direct structuring process for heating the surface of the duct.

In a second exemplary embodiment, a component for a refrigerator appliance is provided. The component includes a body having a surface and an electrically conductive path positioned on the surface of the body of the component. The electrically conductive path is formed using a laser direct structuring process and includes a first terminal. The first terminal is configured for electrical connection to a power source. The electrically conductive path provides heat to the body of the component when the first terminal is electrically connected to the power source.

In an exemplary aspect, a method for forming a component for a refrigerator appliance is provided. The method includes forming the component of a thermoplastic material including a metal-plastic additive and activating the metal-plastic additive with a laser by directing the laser towards the component in a path along a surface of the component. The method also includes submerging at least a portion of the component in a liquefied metallic compound bath such that at least a portion of the liquefied metallic compound adheres to the component on the path along the surface of the component. After submerging at least a portion of the component in the liquefied metallic compound, the component includes an electrically conductive path extending along the surface of the component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 provides a front, elevation view of the exemplary refrigerator appliance of FIG. 1. In FIG. 2, refrigerator doors of the exemplary refrigerator appliance are shown in an open position in order to reveal a fresh food chamber of the exemplary refrigerator appliance.

FIG. 3 provides an elevation view of an air duct in accordance with an exemplary embodiment of the present disclosure.

FIG. 4 provides a close-up view of a surface of an air duct in accordance with another exemplary embodiment of the present disclosure.

FIG. 5 provides a flow diagram of a method for forming a component in accordance with an exemplary aspect of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

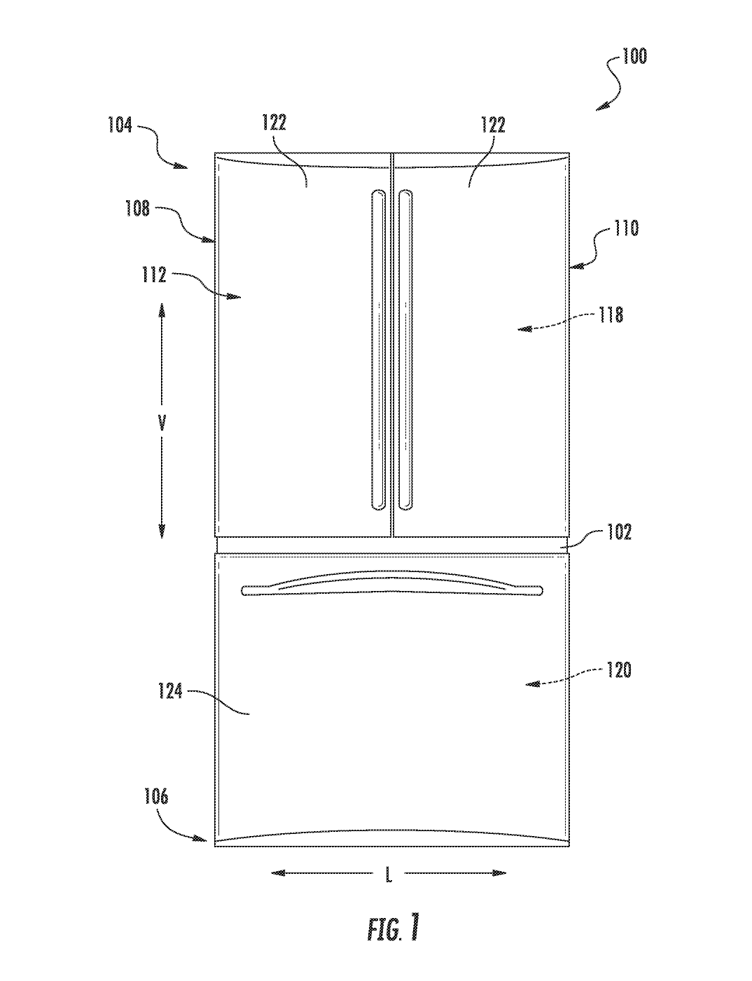

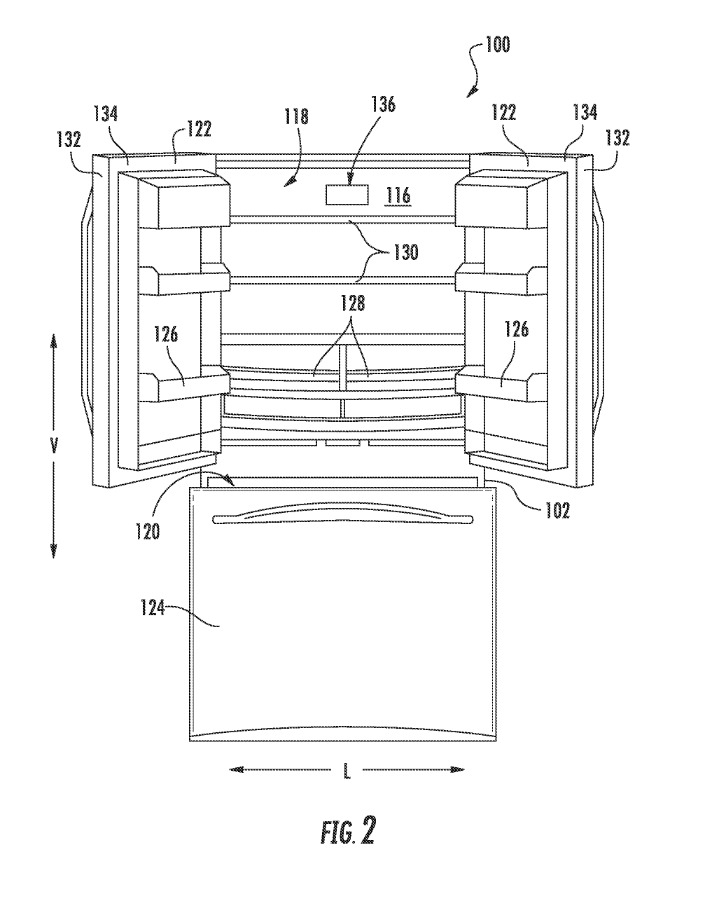

FIG. 1 provides a front, elevation view of a refrigerator appliance 100 according to an exemplary embodiment of the present subject matter with refrigerator doors 122 of the refrigerator appliance 100 shown in a closed position. FIG. 2 provides a front view of refrigerator appliance 100 with refrigerator doors 122 shown in an open position to reveal a fresh food chamber 118 of refrigerator appliance 100.

Refrigerator appliance 100 includes a cabinet or housing 102 that extends between a top 104 and a bottom 106 along a vertical direction V, between a first side 108 and a second side 110 along a lateral direction L, and between a front side 112 and a rear side (not shown) along a transverse direction. Additionally, cabinet 102 includes a liner 116 (FIG. 2), and the liner 116 defines a chilled chamber for receipt of food items for storage. In particular, liner 116 defines two chilled chambers—a fresh food chamber 118 positioned at or adjacent top 104 of cabinet 102 and a freezer chamber 120 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 122 are rotatably hinged to an edge of cabinet 102 for selectively accessing fresh food chamber 118. In addition, a freezer door 124 is arranged below refrigerator doors 122 for selectively accessing freezer chamber 120. Freezer door 124 is coupled to a freezer drawer (not shown) slidably mounted within freezer chamber 120. As discussed above, refrigerator doors 122 and freezer door 124 are shown in the closed configuration in FIG. 1, and refrigerator doors 122 and freezer door 124 are shown in the open position in FIG. 2.

Referring now particularly to FIG. 2, various storage components are mounted within fresh food chamber 118 to facilitate storage of food items therein as will be understood by those skilled in the art. In particular, the storage components include bins 126, drawers 128, and shelves 130 that are mounted within fresh food chamber 118. Bins 126, drawers 128, and shelves 130 are configured for receipt of food items (e.g., beverages and/or solid food items) and may assist with organizing such food items. As an example, drawers 128 can receive fresh food items (e.g., vegetables, fruits, and/or cheeses) and increase the useful life of such fresh food items.

As also may be seen in FIG. 2, refrigerator doors 122 include outer panels 132 and inner liners 134. Each refrigerator door of refrigerator doors 122 includes a respective one of outer panels 132 and inner liners 134 mounted to each other. Insulation, such as sprayed polyurethane foam, may be disposed between outer panels 132 and inner liners 134 within refrigerator doors 122 in order to assist with insulating fresh food chamber 118 when refrigerator doors 122 are in the closed position. Outer panels 132 and inner liners 134 may be constructed of or with any suitable materials. For example, outer panels 132 may be constructed of or with a metal, such a stainless steel or painted steel, and inner liners 134 may be constructed of or with a suitable plastic material. Freezer door 124 may be constructed in a similar manner as refrigerator doors 122.

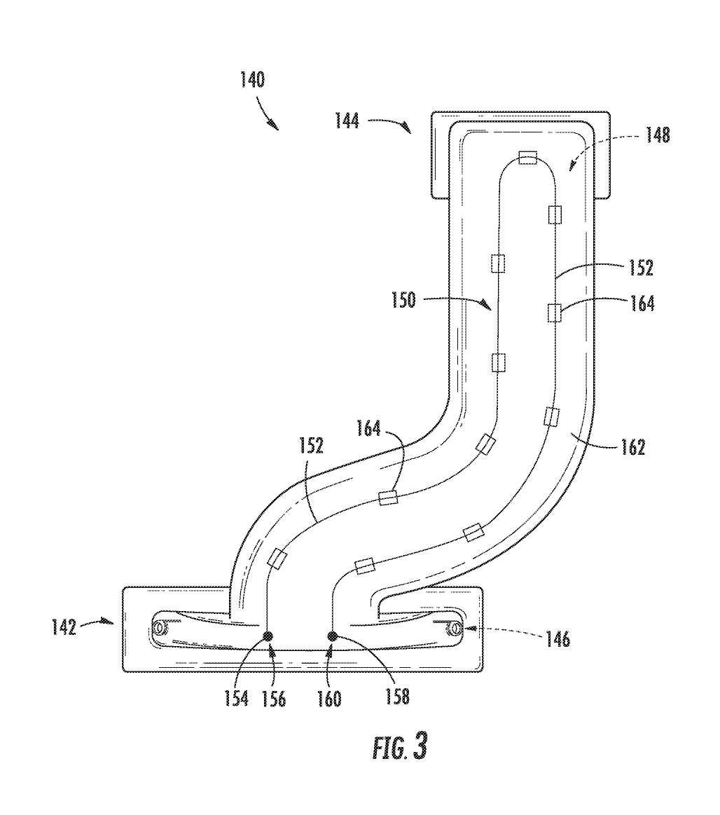

Although not depicted, refrigerator appliance 100 further includes a sealed system for cooling air and a delivery system for delivering such cold air to fresh food chamber 118 and freezer chamber 120. In certain embodiments, the sealed system may include a condenser, an expansion device, evaporator, and a compressor. Such a sealed system may manipulate a refrigerant such that the refrigerant passing through the evaporator defines a relatively low temperature. Moreover, as will be discussed in greater detail below, a supply duct having an integrated heater (such as the air duct 140 discussed below with reference to FIG. 3) may be provided within the cabinet configured to allow a flow of cooled air from the sealed system to a chilled chamber of the refrigerator appliance 100. For example, the supply duct of the refrigerator appliance 100 may be configured to allow a flow of cooled air from the sealed system to the fresh food chamber 118 through an opening 136 in the liner 116. However, in other exemplary embodiments, the refrigerator appliance 100 may instead include a supply duct configured to allow a flow of cooled air from the sealed system to the fresh food chamber 118 through a plurality of openings in the liner 116, or alternatively to the freezer chamber 120. In such an exemplary embodiment, a separate duct may be provided between the freezer chamber 120 and the fresh food chamber 118, such that cooled air from the freezer chamber 120 may be provided to the fresh food chamber 118.

Referring now to FIG. 3, a component for a refrigerator appliance including a heater integrated therein in accordance with an exemplary embodiment of the present disclosure is provided. More particularly, for the embodiment depicted, the component is an air duct 140, such as the supply duct described above with reference to FIG. 2.

The air duct 140 generally includes a first end 142 and a second end 144, with the first end 142 including an inlet 146 configured to receive cooled air from, e.g., a sealed system of the refrigerator appliance, and the second end 144 including an outlet 148 configured to provide such cooled air to, e.g., a fresh food chamber of a refrigerator appliance. However, in other exemplary embodiments, the air duct 140 may instead be configured to provide a flow of cooled air, e.g., from the sealed system to a freezer chamber, or between the freezer chamber and a fresh food chamber.

The air duct 140 also includes a surface 150, i.e., an outer surface, having a heater integrated therewith. More particularly, the surface 150 has an electrically conductive path 152 thereon formed using a laser direct structuring process, as will discussed below. The electrically conductive path 152 is configured for heating the surface 150 of the air duct 140. More particularly, the electrically conductive path 152 extends between a first terminal 154 positioned at a first end 156 of the electrically conductive path 152 and a second terminal 158 positioned at a second end 160 of the electrically conductive path 152. The first and second terminals 154, 158 are configured for electrical connection to a power source (not shown).

The air duct 140 generally includes a body 162 formed of a thermoplastic material, such as polyvinyl chloride (PVC), acrylonitrile butadiene styrene (ABS), polyphenylene sulfide (PPS), etc. By contrast, for the embodiment depicted, the electrically conductive path 152 is formed of copper or copper compound. The electrically conductive path 152 may act generally as an electrical resistance heater to heat the surface 150 of the air duct 140 and raise a temperature of the surface 150 of the air duct 140 above a dew point temperature. The body 162 may electrically insulate the electrically conductive path 152. Thus, during operation of a refrigerator appliance, the electrically conductive path 152 may prevent a formation of condensation on the surface 150 of the air duct 140.

Referring still to the embodiment depicted in FIG. 3, the air duct 140 additionally includes one or more electrical resistors 164 attached to the surface 150 of the duct 140 and in electrical communication with the electrically conductive path 152. Electrical resistors 164 may allow for increased heating of the outer surface 150 of the duct 140 by increasing a resistance on an electrical current flowing therethrough (reducing current flow and/or lowering a voltage of such flow). The electrical resistors 164 may provide a fixed amount of resistance, or alternatively the electrical resistors 164 may provide a variable amount of resistance based on, e.g., certain ambient conditions such as temperature, humidity, etc.

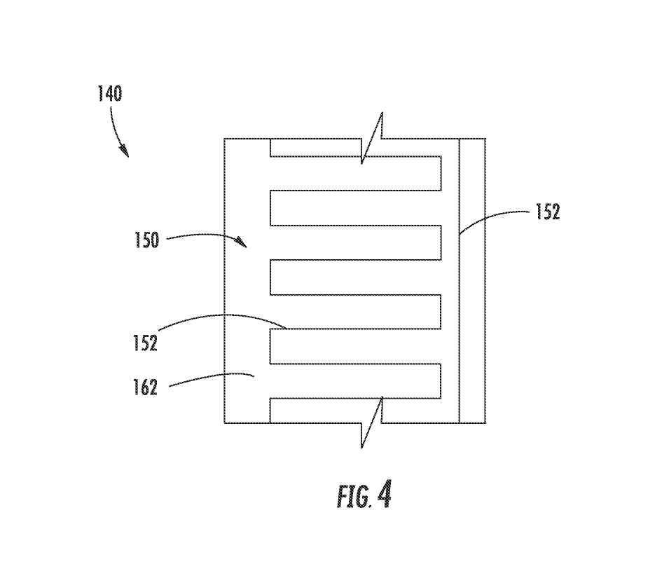

Additionally, for the embodiment depicted, the electrically conductive path 152 extends generally in an elongated U-shaped manner along a length of the duct 140. It should be appreciated, however, that in other exemplary embodiments, the electrically conductive path 152 may extend in any other suitable manner along the surface 150 of the duct 140. For example, referring to FIG. 4, providing a close-up view of a surface of a duct 140 in accordance with another exemplary embodiment, the electrically conductive path 152 may extend substantially across a width of the duct 140 and wind its way along a length of the duct 140. Such a configuration may provide additional heat to the outer surface 150 of the duct 140. Additionally, or alternatively, in other exemplary embodiments, the electrically conductive path 152 may include one or more portions configured in parallel flow with one another.

Further, it should also be appreciated, that in other exemplary embodiments, the component may not be an air duct, and instead may be any other component thermally influenced by the cooled air of the refrigerator appliance, wherein it may be desirable to prevent formation of condensation thereon. For example, in certain exemplary embodiments, the component may be a vacuum sealed panel or other outer panel of the refrigerator appliance, such as an outer door panel or outer cabinet panel. With such an embodiment, a reduced amount of insulation may be provided between the chilled chamber(s) and the outer door panel or outer panel, thus allowing for an increased usable volume within the chilled chamber(s). Additionally, or alternatively, the component may be a component kept at a higher temperature within the cabinet of the refrigerator appliance. For example, in certain exemplary embodiments, the component may be a hot water container of the refrigerator appliance. For example, the refrigerator appliance may include a hot water dispenser in fluid communication with the hot water container. In such an embodiment, an inner surface of the hot water container may include an electrically conductive path formed using a laser direct structuring process for heating the contents of the hot water container.

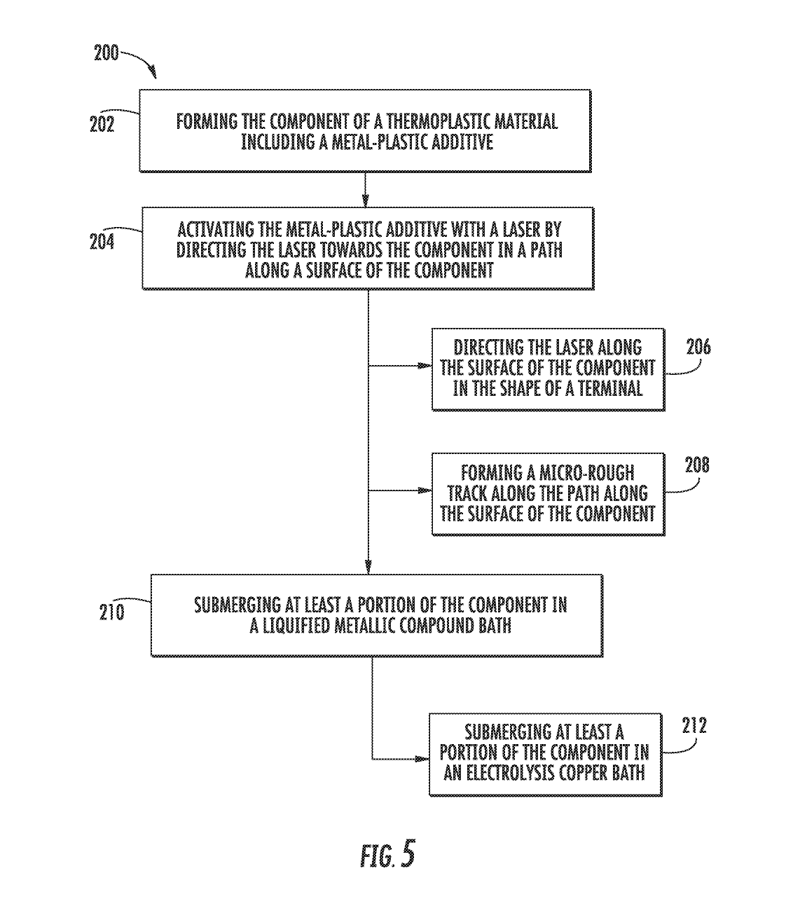

Referring now to FIG. 5, a method (200) is illustrated for forming a component of a refrigerator appliance in accordance with an exemplary aspect of the present disclosure including an electrically conductive path formed using a laser direct structuring process. For example, the exemplary method (200) may be used to form the air duct described above with reference to FIG. 3, or alternatively, any other suitable component, such as a vacuum sealed panel or a hot water container.

The exemplary method (200) includes at (202) forming the component of a thermoplastic material including a metal-plastic additive. For example, forming the component at (202) may include injection molding the component, or alternatively, forming the component using a three dimensional printer.

The exemplary method (200) additionally includes at (204) activating the metal-plastic additive with a laser by directing the laser towards the component in a path along a surface of the component. The path may have any suitable shape along the surface of the component, such as an elongated U-shape, a “zigzag” shape, a spiral shape, or any other suitable shape. Moreover, for the exemplary aspect depicted, activating the metal-plastic additive at (204) includes at (206) directing the laser along the surface the component in the shape of a terminal. For example, directing the laser along the surface of the component the shape of a terminal at (206) may include directing the laser in a circular shape along the surface of the component. However, in other embodiments, the terminal may have any other suitable shape to allow for an electrical connection therewith.

Moreover, for the exemplary aspect depicted, activating the metal-plastic additive with a laser by directing the laser towards the component in a path along the surface of the component at (204) additionally includes at (208) forming a micro-rough track along the path along the surface the component. The micro-rough track may form the nuclei for subsequent metallization.

Referring still to FIG. 5, the exemplary method (200) depicted additionally includes at (210) submerging at least a portion of the component and a liquefied metallic compound bath such that at least a portion of the liquefied metallic compound adheres to the component on the path along the surface of the component. More specifically, for the aspect depicted, submerging at least a portion of the component and a liquefied metallic bath at (210) includes at (212) submerging at least a portion of the component an electrolysis copper bath.

After submerging at least a portion of the component and the liquefied metallic compound at (210) the component includes an electrically conductive path extending along the surface of the component. For example, while submerged within the liquefied metallic compound bath, the metallic compound therein, such as copper, may attach to the portions of the component activated at (204).

Moreover, for the exemplary aspect depicted, after submerging at least a portion of the component and the liquefied metallic compound at (210) the component additionally includes a first terminal at a first end of the electrically conductive path configured for connection to a power source. The electrically conductive path is configured to provide heat to the component when in electrical communication with the power source. Accordingly, when the electrically conductive path of the component formed in accordance with the exemplary method (200) is provided electrical power, the electrically conductive path may provide heat to the surface the component, raising a temperature of the surface the component above a dew point temperature to reduce or prevent any condensation forming thereon.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a sealed system for cooling air;
a cabinet including a liner defining a chilled chamber; and
a duct configured to allow a flow of cooled air from the sealed system to the chilled chamber defined by the liner, the duct including a surface having an electrically conductive path formed using a laser direct structuring process for heating the surface of the duct.

2. The refrigerator appliance of claim 1, wherein the electrically conductive path extends between a first terminal and a second terminal, wherein the first terminal and the second terminal are each configured for electrical connection to a power source.

3. The refrigerator appliance of claim 1, wherein the electrically conductive path is formed of copper or a copper compound.

4. The refrigerator appliance of claim 1, wherein the duct additionally includes one or more electrical resistors positioned in electrical communication with the electrically conductive path.

5. The refrigerator appliance of claim 1, wherein the duct includes a body formed of a thermoplastic material.

6. A component for a refrigerator appliance comprising:
a body including a surface; and
an electrically conductive path positioned on the surface of the body of the component, the electrically conductive path formed using a laser direct structuring process and including a first terminal, the first terminal configured for electrical connection to a power source, the electrically conductive path providing heat to the body of the component when the first terminal is electrically connected to the power source.

7. The component of claim 6, wherein the component is an air duct of the refrigerator appliance.

8. The component of claim 6, wherein the component is a vacuum sealed panel of the refrigerator appliance.

9. The component of claim 6, wherein the component is a hot water container of the refrigerator appliance.

10. The component of claim 6, wherein the electrically conductive path additionally includes a second terminal, wherein the electrically conductive path extends from the first terminal to the second terminal, and wherein the second terminal is additionally configured for electrical connection to the power source.

11. The component of claim 6, wherein the body of the component is formed of a thermoplastic material.

12. The component of claim 6, wherein the electrically conductive path is formed of copper or a copper compound.

13. The component of claim 6, wherein the component additionally includes one or more electrical resistors positioned in electrical communication with the electrically conductive path.

14. A method for forming a component for a refrigerator appliance, comprising:
forming the component of a thermoplastic material including a metal-plastic additive;
activating the metal-plastic additive with a laser by directing the laser towards the component in a path along a surface of the component; and
submerging at least a portion of the component in a liquefied metallic compound bath such that at least a portion of the liquefied metallic compound adheres to the component on the path along the surface of the component;
wherein after submerging at least a portion of the component in the liquefied metallic compound, the component includes an electrically conductive path extending along the surface of the component.

15. The method of claim 14, wherein the electrically conductive path is configured for providing heat to the component when the electrically conductive path is in electrical communication with a power source.

16. The method of claim 14, wherein activating the metal-plastic additive includes directing the laser along the surface of the component in the shape of a terminal, and wherein after submerging at least a portion of the component in the liquefied metallic compound, the component additionally includes a first terminal at a first end of the electrically conductive path configured for connection to a power source.

17. The method of claim 14, wherein activating the metal-plastic additive with a laser by directing the laser towards the component in a path along the surface of the component includes forming a micro-rough track along the path along the surface of the component, and wherein submerging at least a portion of the component in a liquefied metallic compound bath includes submerging at least a portion of the component in an electrolysis copper bath.

18. The method of claim 14, further comprising:
attaching one or more resistors to the component in electrical communication with the electrically conductive path.

19. The method of claim 14, wherein the component is an air duct of the refrigerator appliance.

20. The method of claim 14, wherein the component is a hot water container of the refrigerator appliance.
